(19) United States
(12) Patent Application Publication
(10) Pub. No.: US 2012/0290494 A1
(43) Pub. Date: Nov. 15, 2012

(54) SYSTEM AND METHOD FOR SCREENING AND SELECTING PERFORMERS

(75) Inventors: Jules Haimovitz, Beverly Hills, CA (US); David Hope, Laguna Beach, CA (US); Gary Miles Beer, Los Angeles, CA (US)

(73) Assignee: Casting Showcase LLC.

(21) Appl. No.: 13/422,765

(22) Filed: Mar. 16, 2012

Related U.S. Application Data
(60) Provisional application No. 61/454,129, filed on Mar. 18, 2011.

(51) Int. Cl. G06Q 10/06

(52) U.S. Cl. 705/321

(57) ABSTRACT

Methods, systems and articles of manufacture are disclosed for automatically screening and selecting performers and for establishing communications between performers seeking roles and representation, and entities that are capable of providing such roles and representation.

### CLAIM OF PRIORITY UNDER 35 U.S.C. §119

The present application for patent claims priority to Provisional Application No. 61/454,129 entitled “System and Method for Screening and Selecting Performers,” filed Mar. 18, 2011, and assigned to the assignee hereof and hereby expressly incorporated by reference herein.

### TECHNICAL FIELD

Embodiments of the present invention relate to computer-aided systems and methods for screening and selecting talent from a pool of performers.

### BACKGROUND

Many professional, amateur and aspiring actors and other performers and artists need to be seen by professional casting agents, talent agents, and managers in order to achieve (or in some cases enhance) representation necessary to launch and/or extend an acting career. However very few ever get the chance to do so because of the relatively small number of agents and managers compared to the number of actors.

Casting agents, talent agents, and managers continually need new talent. However, they seldom have the time to see or review the capabilities of the multitude of individuals looking for representation.

As a result, there is a long-standing but unfulfilled need in the market for a service that matches talent with representation in a way that allows the work of a large number of individuals to be seen, screened and selected for presentation to agents and mangers.

Existing systems for matching actors and other performers to the needs of casting agents, talent agents and management companies rely on the uncontrolled submission of widely disparate audition materials by actors and aspiring actors. These materials may include resumes, head-shots and videos of the actors performing different roles, and of different length and genre (for example drama, comedy, etc.). The wide range of submissions makes any review and selection process difficult and highly subjective because any two submissions may vary greatly. Additionally, existing systems provide no pre-screening, ranking or quality control mechanisms.

### SUMMARY

Disclosed embodiments relate to systems, methods, apparatus and articles of manufacture for transmitting identical script extracts to actors and other performers and artists in a predefined demographic category, receiving a number of submissions of video files from the actors comprising recorded performances of the identical script extracts and, based on the number of submissions and a predefined number of best performances in the demographic category, determining a number of rounds of evaluation and down-selection and determining a number of groups in each round and a number of submissions in each group.

In one embodiment, each round of evaluation is configured as one of a side-by-side evaluation, a round-robin evaluation and a bracketed single-elimination evaluation.

These and other features of various embodiments, together with the organization and manner of operation thereof, will become apparent from the following detailed description when taken in conjunction with the accompanying drawings, in which like reference numerals are used to refer to like parts throughout.

### BRIEF DESCRIPTION OF THE DRAWINGS

Provided embodiments are illustrated by way of example, and not of limitation, in the figures of the accompanying drawings in which:

FIG. 1 is an overview of an exemplary process according to one embodiment;

FIG. 2 is a flowchart illustrating an exemplary method according to one embodiment;

FIG. 3 is a block diagram of an exemplary system capable of implementing various disclosed embodiments; and

FIG. 4 is an exemplary apparatus capable of implementing various disclosed embodiments.

### DETAILED DESCRIPTION

Embodiments of the present invention may be configured for online operation via a website and may include applications and user interfaces designed for both fixed and mobile user terminals (clients) such as desktop and laptop computers, tablet computers, smart phones and the like. In the following description, the terms website, application and user interface may be used interchangeably. While the following description provides a detailed discussion of exemplary embodiments directed to the screening and selection of actors, the scope of the present disclosure is not so limited. It will be appreciated that other embodiments are contemplated within the scope of the present disclosure that may be directed to other artists and performers such as models, writers, comedians, musicians and the like.

As used herein, the term “user” includes at least the six different categories of users or user types, as follows:

“Actors”—New (unregistered) Actors who wish to download script extracts and Registered Actors (actors registered with the site) who wish to both download script extracts and submit video auditions.

“Reviewers”—Industry experts who will review submissions and select the best performances in each round of evaluation, including “Early Round Reviewers” and “Final Reviewers.”

“Professionals”—Talent agents, talent managers, casting agents, and other industry professionals who wish to view the best performances for the purpose of selecting and/or hiring actors.

“Viewers”—Others, such as the general public, who may be given access to the “Best Performances” or other areas of the site.

“Visitors”—Any combination of the above.

“Administrators”—Personnel who manage the website and mobile applications.

The website may include a home page with links to other pages (sections) that may be accessed by one or more categories of users. Exemplary sections may include:

### Actors' Section

In one embodiment, when an Actor enters the Actors' Section, the application will be configured to determine if the Actor is a new Actor or a Registered Actor and will direct the Actor to a New Actor's Area or a Registered Actor's Area, accordingly.

### New Actors Area

The New Actor's Area may include information, such as:
How the website works
Instructions for submitting audition material
Cost information
Summary information on the types of background of the various reviewers, information related to the bios on a Board of Advisors or possibly a Panel of Expert Reviewers (described below)
Success stories
Sample best performances

New Actors may then have the option to transfer to other areas of the Actors Section, such as:
A Registration Area
A Script Listings Area
A Video Submission Area
A Board of Advisors and/or a Panel of Experts Area containing biographical information

Alternatively, New Actors may transfer to the “Best Performances” section if they wish to view any of the video auditions previously chosen as Best Performances.

### Registration Area

New Actors may be prompted to visit the Registration Area from the New Actors Area. There may also be a link to the Registration Area directly from the Home Page. All actors may be required to register before they can access the Video Submission Area and/or enter the Script Listing Area. In the Registration Area, Actors may be required to enter some or all of the following information:
Name
Address
Email(s)
Phone numbers (e.g., Home and Cell)
Sex
Age
Level of expertise (e.g., professional, amateur, none)
Any guild membership details
Any theater group membership details (name, address, email, phone)
Create a Password

Actors may be asked if they can be contacted about future Script Listings by either email, text, or both, and if they agree to terms and conditions of the site, including a legal disclaimer that the site's decision as to which performances are Best Performances is at the site management's discretion.

In addition, if the submitted video is in a juvenile demographic category, similar information may be required of a parent or guardian.

Once they have registered, Actors may be given a unique Membership Number linked to their registration details and their password.

### Script Listing Area

New Actors may be prompted to visit the Script Listing Area from either the Home Page, the New Actors Area, or the Registration Area. Returning Actors will be able to transfer directly to the Script Listing Area from the Home Page.

In one embodiment, in the Script Listing Area, Actors may log-in using their membership number and password. Administrators may have the ability to switch the log-in requirement on and off to provide unrestricted access that allows visitors to look at some script listings before they register as Actors.

In the Script Listing Area, Actors will be prompted to click on an icon or other means that matches their demographic category (e.g., sex and age range), or a demographic category they would like to submit a video to (for example, an actor may submit videos to more than one demographic if they believe they can pass as an actor in different age groups). Table I, below, illustrates an exemplary set of demographic categories:

SAMPLE ACTOR CATEGORIES

| | | |
|---|---|---|
| Kids | 3-6 | Males |
| | 6-9 | |
| | 9-12 | |
| | 13-15 | |
| | 16-18 | |
| Adults | 18-24 | |
| | 25-34 | |
| | 35-44 | |
| | 45-54 | |
| | 55-64 | |
| | 65+ | |
| Kids | 3-6 | Females |
| | 6-9 | |
| | 9-12 | |
| | 13-15 | |
| | 16-18 | |
| Adults | 18-24 | |
| | 25-34 | |
| | 35-44 | |
| | 45-54 | |
| | 55-64 | |
| | 65+ | |

Administrators may be provided with the option of redefining and/or combining different demographic categories.

When an Actor selects their demographic category, they will be linked to another page that will allow them to select a script extract from a number of script extracts which have been posted over a period of time. In one embodiment, the selection options may correspond to script extracts posted for the current week and for one to three preceding weeks, so that the available script extracts provide a moving window of new and earlier script extracts over time.

In one embodiment, script extracts may be of a length that will take between 45-60 seconds to read. However, other embodiments may allow for shorter or longer script extracts. Each demographic category may be associated, for each week or other time interval, with a different script extract. Alternatively, script extracts may cut across more than one demographic category. For example, the same script extract may be provided for 40-49 year old males and for 50-59 year old males, and auditions based on these script extracts may be merged, for review, into one combined demographic category. Administrator users may be given the authorization to make such changes in the demographic structure and to select specific script extracts.

Each script extract may be associated with a Code Number that identifies the script extract, including the date that the script extract was posted to the website, and the demographic category or categories associated with the script extract. Registered and/or New Actors may be given rights to view, download and print script extracts.

In one embodiment, Registered Actors and/or New Actors may view script extracts posted in demographic categories other than their own, which may encourage them to recommend the website to friends, family, and colleagues in those demographic categories. Registered Actors may also submit video auditions, based on the posted script extracts, to more than one demographic category and/or on more than one video audition in a given demographic category each week (or other time period). In one embodiment, each video (audition) submitted by a Registered Actor will require a separate submission fee from the Registered Actor. In other embodiments, a monthly or annual membership fee may allow Registered Actors to submit more than one video per week. In yet another embodiment, some Registered Actors may be given one or more free submissions such as for example during a “buy 10 get one free promotion” or for other reasons.

### Video Submission Area

Registered Actors may be able to transfer directly to the Video Submission Area from the Home Page after they log-in. If an unregistered Actor attempts to access the Video Submission Area to submit a video base on a script extract they obtained from a third party (e.g., a Registered Actor), they may be redirected to the Registration Area for registration and payment information before they are permitted to upload a video.

The website may allow Actors to upload various forms of video to the Video Submission Area (e.g., mpeg files, avi files, mov files, etc.). Mobile applications may allow Actors to capture and upload video from their smart phones or from tablet devices.

In one embodiment, each submission will be between 45 and 60 seconds in length. Submissions longer than 60 seconds may be blocked to prevent random or unauthorized scripts or videos to be submitted. Length limitations on submitted videos may be adjusted by Administrator users to adjust, for example, for varying speech rates of submitting Actors.

When an Actor visits the Video Submission Area, they may select a script posting date and a demographic category corresponding to their video audition or alternatively by identifying the script extract Code Number described above.

When an Actor uploads a video audition, or video auditions, he may be required to input a Membership Number to be associated with the video or videos. The membership number may be used to validate payment information.

After the payment is processed, the video submission can be accepted as a valid entry and an email may be sent to the Actor alerting him to the fact that his submission has been accepted.

If the payment cannot be processed correctly, an email may be sent to the Actor alerting him that payment could not be processed, providing a reason if possible, and explaining how the payment details need to be corrected.

Once the period of submission for an individual week has closed, no more videos may be uploaded by Actors to that week's set of script extracts. However, all of the uploaded videos may be stored/saved until Best Performances have been chosen. Once the Best Performances have been chosen, other videos may be discarded to conserve storage space. Alternatively, all videos may be stored in archives for future review.

### Board of Advisors/Panel of Experts Area

In one embodiment, the website may include a Board of Advisors Area, where the Board of Advisors comprises a group of senior industry experts. The Board of Advisors may be responsible for providing general advice and guidance. The biographies of the Board of Advisors may be posted on the site. In another embodiment, the site may include a Panel of Experts Area identifying highly qualified talent evaluators who can act as Final Reviewers of video submissions to select the Best Performances in each demographic category to be posted to a Best Performances Section.

The Board of Advisors and/or Panel of Experts may be featured in a promotion of the website, and their resumes may be highlighted on the Home Page to enhance the credibility of the website. In addition, all New and Registered Actors may be prompted to visit the Board of Advisors and/or Panel of Experts Area.

### Reviewers Section

When a set of auditions have closed (e.g., after a predetermined passage of time) the submissions in the different demographic categories may be copied to the Reviewers Section to be reviewed. Each individual video submitted may be coded to identify the submission period, the demographic category, and the Membership Number of the Actor. If an Actor submits more than one video for the same week and demographic category, the submissions may be distinguished by the Actor's Membership Number.

Based on the number of submissions in each demographic category during a submission period, a specified maximum evaluation group size for each round of evaluation, a maximum number of evaluation rounds and a defined number of Best Performances at the end of the evaluation process (e.g., specified by an administrator during a configuration process), the system may be configured to automatically parse the submitted videos into subgroups for evaluation and selection in a first round of evaluation, to specify the number of submissions that get through to the next round from each group and to allocate the survivors of the first round and each successive round of evaluation into evaluation groups.

For example, assume the maximum number of rounds is three, the maximum group size is 40 for a first round evaluation, 20 for a second round evaluation and 15 for a third round evaluation, the number of submissions that get through from each group in each round is three and the specified number of final Best Performances is three. If there are 998 submissions in a given demographic category, the parsing algorithm will divide the 998 submissions into 24 groups of 40 and one group of 38 for a first round of evaluation and selection. The system may then instruct the reviewer of each of the 25 groups to select the three best performances from that group, resulting in 75 first round best performances. The parsing algorithm will then divide the 75 first round best performances into three groups of 20 and one group of 15, which will yield 12 second round best performances. The third round will then consist of one group of 12 from which the three Best Performances are selected. If the algorithm is over-constrained by the administrator (i.e., the constraints cannot be met), then the system will be configured to flag the conflict to the administrator and request a change of constraints.

For example, assume the same constraints as above, but the number of submissions in a demographic category is 10,000. Then, under the stated constraints, the first round will consist of 250 groups of 40, the second round will consist of 37 groups of 20 and one group of 10 and by the third round, there will seven groups of 15 and one group of nine, so the constraints cannot be met. In this situation, the administrator may be prompted to change one or more of the constraints.

Alternatively, the algorithm may automatically adjust the size and number of the pools and the number of rounds, depending on the number of submissions, to meet other constraints (e.g., the number of Best Performances from the final round). Once the group sizes are configured, the groups may then be automatically allocated to individual reviewers based on the reviewers' availability. The pools may then be moved/copied to an individual Reviewer's personal file, protected by a Reviewer's password.

In any round, reviews may be conducted as side-by side reviews, round-robin reviews or bracketed single elimination reviews, either selected by the system based on the Administrator's constraints or as mandated by the Administrators. In a side-by-side review, submissions are paired one-by-one and the winner of each comparison proceeds to a comparison with the next member of the group until the specified number of group survivors remain. In a round-robin review, every member of the group may be compared with every other member of the group before the reviewer makes a selection based on the specified number of group survivors. In a bracketed single-elimination review, the members of the group may be randomly paired with other members of the group into a bracket, like a tournament bracket, where the winner of each pair in the bracket proceeds to the round of the bracket until a winner is selected. This election method may include a consolation bracket if the constraints require more than one or two best performances from the round.

When a group, or series of groups, is moved into an individual Reviewer's personal file, that Reviewer receives an automatic email notifying them that they have videos available to Review. When a Reviewer visits the website they may select a tab on the home page that will link them to a secure page where they may enter their name and their password. Once the credentials are validated by the system, the Reviewer can gain access to their personal file and a reviewing page. All accesses may be tracked and recorded by the system.

### Early Round Reviews

The following describes an exemplary process associated with a side-by-side evaluation method, as briefly described above. Those of skill in the art will appreciate that the general principles described herein may also be applied to the round-robin and bracketed single-elimination processes.

A reviewer may start the review process by selecting a “Start Review” button on the review page, where the first two videos in the Reviewer's pool (e.g., based on order of submission, randomly selected by the system, etc.) appear in video windows on the Reviewer's display screen for “side-by-side” comparison. The video windows may be located literally side-by-side, for example, or in any configuration selected by the Reviewer dragging and dropping the windows as is known in the art. The Reviewer selects and play's the two videos for comparison. The Reviewer may replay either video at any time. When the Reviewer chooses one of the two videos as the better performance, the reviewer can remove the other video by clicking on a “Reject” button below that video. As soon as one video is rejected, it is automatically replaced by another video from the same pool. The Reviewer then plays this video, compares it to the other video still on the screen, and once again rejects the video he likes the least. This process of comparison and rejection continues until one video remains. This video is then automatically transferred to a round one best performances file for the current audition period and the demographic category to which the initial group belonged.

This early review process may include additional features. For example, when a video is reviewed, an email may be automatically generated and sent to the Actor who submitted the video, letting the Actor know that the video has been reviewed. The system may also be configured to keep a record of all reviews (e.g., with a time and date stamp) so that Administrators can verify, for example, that a Reviewer has actually reviewed that video. The system may also be configured to prevent a Reviewer from rejecting a video before a minimum percentage of the video (e.g., 50%) has been viewed by the Reviewer.

In one embodiment, the number and/or percentage of submitted videos that obtain early round best performances status may be controlled by adjusting the size of the initial groups. For example, if the pool size is 40 then 2.5% ( 1/40^{th}) of submissions will make it through. If the pool size is reduced to 20 then 5% ( 1/20^{th}) of submissions will make it through. In the example above, if there are 1,000 submissions in a particular demographic category, and these are divided into 25 pools of 40, then 25 performances will make it into the early round best performances file for that particular audition period and that particular demographic category. If the group size is reduced to 20, then 50 performances will make it through, etc. By being able to alter the individual group sizes, any total number of submissions may be accommodated to produce a desired percentage or number of early round best performances that will be subjected to additional levels of review, as described above.

### Final Review

The final review process may be similar to the Early Review process, except that the reviewers may have more experience than Early Reviewers and/or more industry recognition and credibility than early reviewers. The early round best performances for a particular demographic category and audition period may be divided into groups depending on the number of video auditions that have attained that status. The group or groups are then allocated to another round of review and placed in a reviewer's file and the system automatically notifies the Reviewer by email that the Reviewer has videos to review.

The Final Reviewer accesses the website, navigates to the Reviewers' log-in page and enters their name and password. Once the Final Reviewer is logged-in, he is linked to a review page as described above for the Early Review process, and reviews the Stage 1 Best Performances in the same way, except that the Final Reviewer may have the opportunity to select more than one Best Performance.

Continuing the example above, assuming 1,000 submissions in a particular audition period and a particular demographic category, and pools of 40 videos, the Early Reviewers will have selected 25 videos as early round best performances. These 25 videos will go into one new pool to be reviewed by one Final Reviewer. If the initial pool size was 20, then 50 videos will have been selected, and these 50 videos may form one pool or may be divided into 2 pools of 25 for two Final Reviewers to review, for example.

As described above for the Early Review process, a Final Reviewer will be able to view two videos at a time, reject one, do a second comparison and so on. Unlike the Early Review process, however, the Final Reviewer may identify and retain two or more selections, at the Final Reviewer's discretion, based on the quality of the submissions. For example, for one audition period a Final Reviewer may decide there are five worthy performances, while for another audition period he may decide there is only one performance of adequate quality.

In one embodiment, the system may be configured to provide locations on the Final Reviewer's screen for “Runners-up,” whereby the Final Review can save videos into an ordered queue, rather than reject the videos. One mechanism may be to let the Final Reviewers have the ability to not only reject a video but to save a video to another part of the screen. Thus there may be two or three “runner-up” boxes at the bottom of the screen and an additional icon so that the Final Reviewer can select “Reject” to reject a video or can drag and drop a video to one of these “runner-up” boxes. If a later video is a better runner-up they can drag and drop this video over the prior runner-up which then replaces that runner-up.

Once the Final Reviewer has selected the Best Performances (a.k.a “Very Best Performances”) for the current audition period for a particular demographic category, those videos may be automatically copied or moved to the Best Performances Section. Once the Best Performances videos from any audition period are posted to the Best Performances Section (described below), an email may be sent automatically to every member of the site (e.g., Actors, Professionals, Administrators) to alert them that the Best Performances are available for viewing. The emails may be customized for each category of member. For example, Actors who submitted videos may receive a different email than Actors who did not submit videos. In an alternative embodiment, the Early Review process may also allow Reviewers to keep “runners-up” in a similar manner to the Final Reviewers.

As described above, there may be three, four or more levels of review, depending on the number of submissions in any demographic category.

In an alternative embodiment, reviewers may be able to rank submissions by, for example, giving each submission a mark out of 10 where 10 denotes the best performances and 1 the worst performances. Videos are then stored by rank, and the reviewers can call back videos based upon rank.

### Best Performances Section

The Best Performances Section is where all Best Performance videos chosen from each audition period and each demographic category are automatically posted. Access to the Best Performances Section may be controlled by Administrators with respect to Professionals, Actors, Viewers and Visitors.

Visitors to the Home Page may be given open access to and be prompted to visit the Best Performances Section. In one embodiment, a selection of Best Performances may run in rotation on the Home Page. Alternatively, Visitors may be required to register before they receive access to the Best Performances. Best Performances may be archived indefinitely or deleted after a predetermined period of time.

Each Best Performance video may be identified by an individual Video Identification Number (VIN), which may be visible next to the video together with a Code Number identifying the script that is performed in the video. Personal identification information for the Actor (e.g., name, membership number, etc.) will not be available. In the Best Performances Section, Visitors may have the ability to search the Best Performances by audition period, demographic category, sex, age, membership number (allowing Actors to find their own videos directly, or agents and managers to find Actors of a particular type they may be looking for), script code number (to access all Best Performances of a given script), Video Identification Number (enabling returning Visitors to find a video they have viewed before), most viewed videos, best rated videos and Success Stories (videos that have attracted interest from Professionals).

### Actor Database Area

Once a Best Performance video is posted to the Best Performances Section, an email may be automatically sent to the respective Actor, requesting the Actor to upload a resume and a photograph (e.g., a head shot) to the site, identified by the Actor's membership number. Upon receipt, the resume and photograph are automatically saved in a file under the Actor's membership number for later retrieval.

### Professional Access Area

The Best Performances Section will include a link to a page that allows industry Professionals, such as talent agents, talent managers, and casting agents to contact the site and request information on any Best Performances video. This area can allow the Professionals to automatically contact (e.g., email) Administrators to request such details. An email form may prompt the Professional for information such as the name of the Professional, the name of the Professional's company or affiliation, address, phone number, email, password (for Registered Professionals), company web site, company type (e.g., Agent/Manager/Casting/Other), VINs (e.g., up to some maximum number), level of interest from a popup menu (e.g., “want more details”, “interested in more videos on this individual”, “interested in contacting the Actor”, “interested in meeting the Actor”, etc.)

The Professional may also be required to agree to report the outcome of any contact with an Actor in order to support the generation of Success Stories. The emails received from Professionals may be automatically screened against an Approved Professionals database of known and/or Registered Professionals. Email requests that cannot be associated with a known or Registered Professional will trigger an Administrator alert so that an Administrator can manually review the request an check the credentials of the requestor and classify them as, for example, an “Approved Professional”, “Not Approved”, or “Need Further Information”. Approved Professional's details can be saved to an Approved Professionals database on the website that can be accessed by Administrators only. Once a Professional is approved, an email can be automatically sent to the Actor with the name and contact details of the Professional so that the Actor has control over the contact. The system may automatically and periodically send emails to the Actor requesting updated information regarding any advancement in the Actor's relationship with the Professional to track Success Stories.

### Success Stories Area

The Best Performances Section will include a link to an area of the website or mobile application that promotes Success Stories. There may also be a direct link to this section from the Home Page and from the Actors Section. Recent Success Story details may also be promoted in rotation on the Home Page, as described above. Success Stories will identify Actors who have has interactions with Professionals as a result of using the system. The type of interaction may be identified, such as requests for further details on the Actor, contact from a Professional, meetings with a Professional, casting calls, roles won, agency representation acquired, management representation acquired, etc.

Success Stories may also include copies of the Actor's video, interviews with the Actor and the like. Success Stories may also be tracked over time, as Actors move from initial contact to meetings to actual representation and future acting roles.

Emails may be sent automatically to all members, detailing any particularly Success Stories.

### Administrators' Section

The Administrators' Section is configured to provide management with the ability to manage various functions of the website, including user account access, script management, elements of the review process and promotions (e.g., maintenance of Final Reviewer biographies, Success Stories, and Best Performances). All user transactions may be tracked and available for recall in the event that any operational issues arise.

### Administrator Access

A super administrator may be defined who has the ability to add or delete other Administrators.

### Account Management

An “Administrator” has the authority to manage one or more accounts. Account management includes the suspension and deletion of Actors, the addition, suspension and deletion of Reviewers and the approval, suspension, and deletion of Professionals.

### Review Management

The system will be configured to provide automated back office support to Administrators, enabling them to ensure that reviews are completed in a timely fashion at the highest quality. An Administrator will have visibility into the video clip appropriation process and be able to set the pool sizes for each audition period and demographic category. Additionally, an Administrator may monitor the review process to ensure a timely hand-off between Early and Final reviewers as well as a timely completion of the review process. Administrators may communicate with the various reviewers (scheduling and notification) and reallocate review pools as required.

### Script Management

Scripts may be uploaded by Administrators and associated with the appropriate demographic category. Administrators may also have the ability to delete a script. When an Administrator uploads a script, an automatic email may be sent to notify registered users that have opted to be notified when new auditions begin.

### Manage Promotions

Various promotions may include Reviewer Bios, Best Performances, and Success Stories as noted above. An Administrator may maintain each of these promotional categories by adding, editing, and deleting content from the respective pages.

### Issue Resolution

All users may have the ability to submit a question or comment for an Administrator to resolve and to access a Frequently Asked Questions (FAQ) page or Help Page which may be managed by an Administrator.

In one embodiment, there may be separate competitions amongst the Best Performances. There may be an annual comparison of all Best Performances posted to the Best Performances site and subjected to a similar Review process to find the Best of the Best. Prizes, such as a contract with a talent agent, a role in a movie or TV show, cash, etc. may be offered. Alternatively, prizes may be offered on a weekly, monthly or other basis.

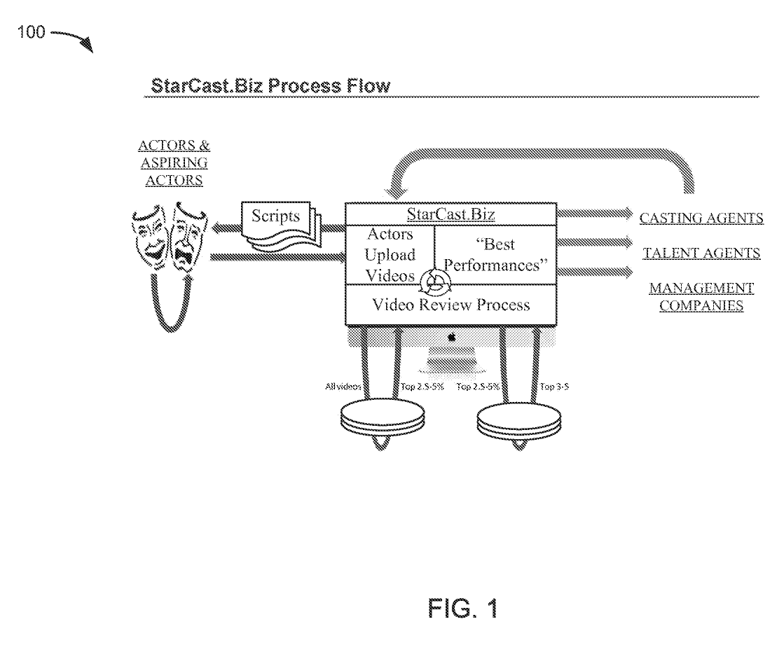

FIG. 1 is a process diagram 100 summarizing the operation of an exemplary system according to various embodiments described above. As illustrated in FIG. 1, scripts may be periodically posted to the website (e.g., every two weeks), with different scripts targeted to different demographic categories. Actors and aspiring actors can record themselves performing the scripts and upload the performances to the website for a nominal fee (e.g., $10.00). All video submissions are reviewed by industry professionals to select a limited number of best performances (e.g., 2-5%) for subsequent review by senior industry professionals where, for example, the best two or three performances in each demographic category may be selected for posting in the Very Best Performances section of the website. These Very Best Performances may then be viewed by talent seekers such as casting agents, talent agents and management companies as described above. Success stories resulting from contacts between Actors and the talent seekers are then reported and promoted on the website

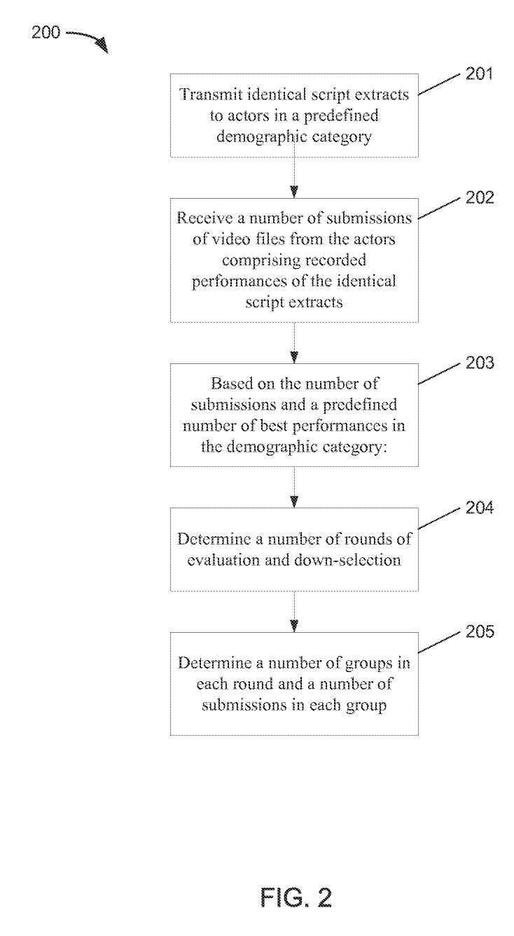

FIG. 2 is a flowchart 200 illustrating an exemplary method according to one embodiment. The method begins at operation 201, where the system transmits identical script extracts to actors in a predefined demographic category. At operation 202, the system receives a number of submissions of video files from the actors comprising recorded performances of the identical script extracts, and at operation 203, based on the number of submissions and a predefined number of best performances in the demographic category, at operation 204, the system determines a number of rounds of evaluation and down-selection and at operation 205, determine a number of groups in each round and a number of submissions in each group.

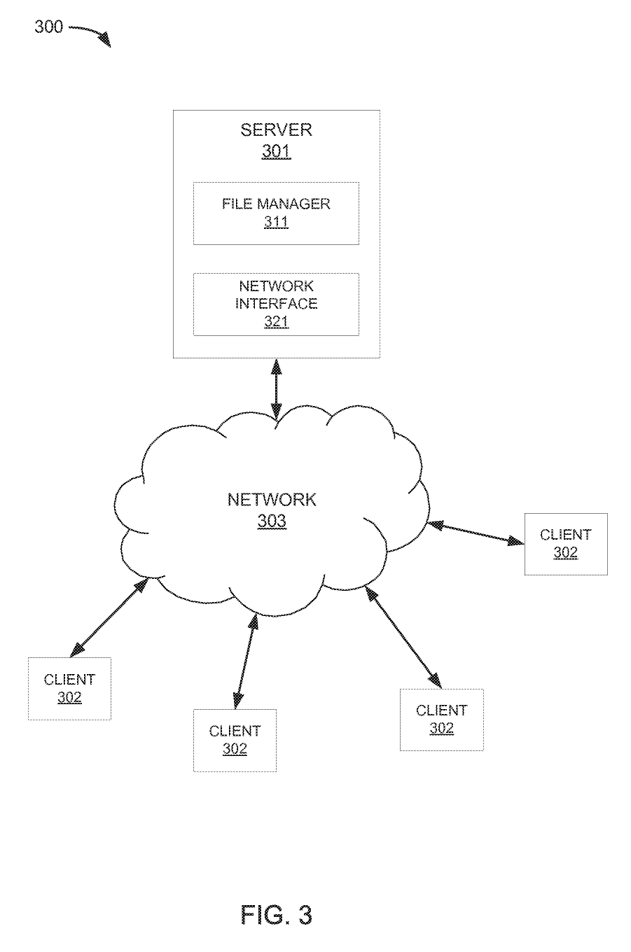

FIG. 3 illustrates a system 300 capable of supporting the various operations described above. System 300 includes a server 301 having a file management module 311 configured to manage files and data such as video files of recorded performances, subscriber databases, reviewer databases, registered professional databases and the like. Server 301 also includes a network interface module 321 that can transmit and/or receive information, signals, data, instructions, commands, bits, symbols and the like. The server 301 can communicate with one or more clients 302 via a network 303, such as the Internet, for example.

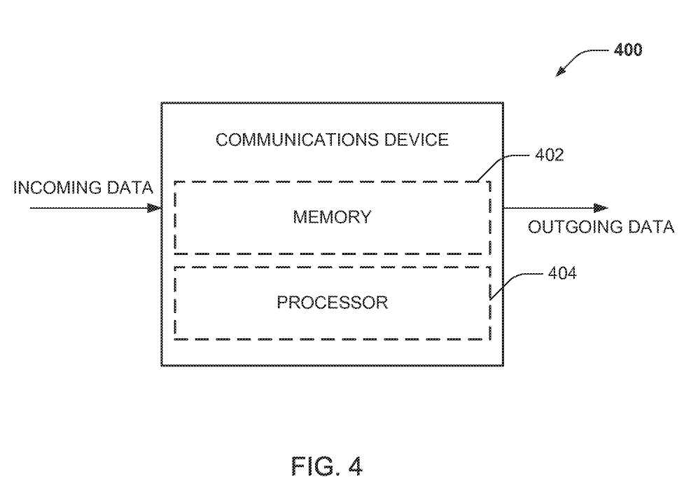

FIG. 4 illustrates an apparatus 400 within which the various disclosed embodiments may be implemented. In particular, the apparatus 400 that is shown in FIG. 4 may comprise at least a portion of server such as server 301 depicted in FIG. 3. FIG. 4 illustrates that the apparatus 400 can include a memory 402 that can retain instructions for performing one or more operations, such as file and data management. Additionally, the apparatus 400 of FIG. 4 may include a processor 404 that can execute instructions that are stored in the memory 402 and/or instructions that are received from another device, such as a client 302 depicted in FIG. 3. The instructions can relate to, for example, configuring or operating the apparatus 400 or a related communications apparatus. It should be noted that while the memory 402 that is depicted in FIG. 4 is shown as a single block, it may comprise two or more separate memories that constitute separate physical and/or logical units. In addition, the memory while being communicatively connected to the processor 404, may reside fully or partially outside of the apparatus 1000. It is also to be understood that one or more components, such as the server 301 depicted in FIG. 3 can exist within a memory such as the memory 402.

It will be appreciated that the memories that are described in connection with the disclosed embodiments can be either volatile memory or nonvolatile memory, or can include both volatile and nonvolatile memory. By way of illustration, and not limitation, nonvolatile memory can include read only memory (ROM), programmable ROM (PROM), electrically programmable ROM (EPROM), electrically erasable ROM (EEPROM) or flash memory. Volatile memory can include random access memory (RAM), which acts as external cache memory. By way of illustration and not limitation, RAM is available in many forms such as synchronous RAM (SRAM), dynamic RAM (DRAM), synchronous DRAM (SDRAM), double data rate SDRAM (DDR SDRAM), enhanced SDRAM (ESDRAM), Synchlink DRAM (SLDRAM) and direct Rambus RAM (DRRAM).

It should also be noted that the apparatus 400 of FIG. 4 can be employed as a user terminal or mobile device, and can be, for instance, a module such as an SD card, a network card, a wireless network card, a computer (including laptops, desktops, personal digital assistants PDAs), mobile phones, smart phones or any other suitable terminal that can be utilized to access a network.

It is to be understood that the embodiments and features that are described herein may be implemented by hardware, software, firmware or any combination thereof. Various embodiments described herein are described in the general context of methods or processes, which may be implemented in one embodiment by a computer program product, embodied in a computer-readable medium, including computer-executable instructions, such as program code, executed by computers in networked environments. As noted above, a memory and/or a computer-readable medium may include removable and non-removable storage devices including, but not limited to, Read Only Memory (ROM), Random Access Memory (RAM), compact discs (CDs), digital versatile discs (DVD) and the like. When implemented in software, the functions may be stored on or transmitted over as one or more instructions or code on a computer-readable medium. Computer-readable media includes both computer storage media and communication media including any medium that facilitates transfer of a computer program from one place to another. A storage media may be any available media that can be accessed by a general purpose or special purpose computer. By way of example, and not limitation, such computer-readable media can comprise RAM, ROM, EEPROM, CD-ROM or other optical disk storage, magnetic disk storage or other magnetic storage devices, or any other medium that can be used to carry or store desired program code means in the form of instructions or data structures and that can be accessed by a general-purpose or special-purpose computer, or a general-purpose or special-purpose processor.

Also, any connection is properly termed a computer-readable medium. For example, if the software is transmitted from a website, server, or other remote source using a coaxial cable, fiber optic cable, twisted pair, or digital subscriber line (DSL), then the coaxial cable, fiber optic cable, twisted pair, or DSL are included in the definition of medium. Disk and disc, as used herein, includes compact disc (CD), laser disc, optical disc, digital versatile disc (DVD), floppy disk and blu-ray disc where disks usually reproduce data magnetically, while discs reproduce data optically with lasers. Combinations of the above should also be included within the scope of computer-readable media.

Generally, program modules may include routines, programs, objects, components, data structures, etc., that perform particular tasks or implement particular abstract data types. Computer-executable instructions, associated data structures and program modules represent examples of program code for executing steps of the methods disclosed herein. The particular sequence of such executable instructions or associated data structures represents examples of corresponding acts for implementing the functions described in such steps or processes.

The various illustrative logics, logical blocks, modules, and circuits described in connection with the aspects disclosed herein may be implemented or performed with a general purpose processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general-purpose processor may be a microprocessor, but, in the alternative, the processor may be any conventional processor, controller, microcontroller or state machine. A processor may also be implemented as a combination of computing devices, e.g., a combination of a DSP and a microprocessor, a plurality of microprocessors, one or more microprocessors in conjunction with a DSP core, or any other such configuration. Additionally, at least one processor may comprise one or more modules operable to perform one or more of the steps and/or actions described above.

For a software implementation, the techniques described herein may be implemented with modules (e.g., procedures, functions and so on) that perform the functions described herein. The software codes may be stored in memory units and executed by processors. The memory unit may be implemented within the processor and/or external to the processor, in which case it can be communicatively coupled to the processor through various means as is known in the art. Further, at least one processor may include one or more modules operable to perform the functions described herein.

Moreover, various aspects or features described herein may be implemented as a method, apparatus or article of manufacture using standard programming and/or engineering techniques. The term “article of manufacture” as used herein is intended to encompass a computer program accessible from any computer-readable device, carrier or media. For example, computer-readable media can include but are not limited to magnetic storage devices (e.g., hard disk, floppy disk, magnetic strips, etc.), optical disks (e.g., compact disk (CD), digital versatile disk (DVD), etc.), smart cards, and flash memory devices (e.g., EPROM, card, stick, key drive, etc.). Additionally, various storage media described herein can represent one or more devices and/or other machine-readable media for storing information. The term “machine-readable medium” can include, without being limited to, media capable of storing, containing, and/or carrying instruction(s) and/or data. Additionally, a computer program product may include a computer readable medium having one or more instructions or codes operable to cause a computer to perform the functions described herein.

Further, the steps and/or actions of a method or algorithm described in connection with the aspects disclosed herein may be embodied directly in hardware, in a software module executed by a processor, or in a combination of the two. A software module may reside in RAM memory, flash memory, ROM memory, EPROM memory, EEPROM memory, registers, a hard disk, a removable disk, a CD-ROM or any other form of storage medium known in the art. An exemplary storage medium may be coupled to the processor, such that the processor can read information from, and write information to, the storage medium. In the alternative, the storage medium may be integral to the processor. Further, in some embodiments, the processor and the storage medium may reside in an ASIC. Additionally, in some embodiments, the steps and/or actions of a method or algorithm may reside as one or any combination or set of codes and/or instructions on a machine readable medium and/or computer readable medium, which may be incorporated into a computer program product.

While the foregoing disclosure discusses illustrative embodiments, it should be noted that various changes and modifications could be made herein without departing from the scope of the described embodiments as defined by the appended claims. Accordingly, the described embodiments are intended to embrace all such alterations, modifications and variations that fall within scope of the appended claims. Furthermore, although elements of the described embodiments may be described or claimed in the singular, the plural is contemplated unless limitation to the singular is explicitly stated. Additionally, all or a portion of any embodiment may be utilized with all or a portion of any other embodiments, unless stated otherwise.

To the extent that the term “includes” is used in either the detailed description or the claims, such term is intended to be inclusive in a manner similar to the term “comprising” as “comprising” is interpreted when employed as a transitional word in a claim. Furthermore, the term “or” as used in either the detailed description or the claims is intended to mean an inclusive “or” rather than an exclusive “or.” That is, unless specified otherwise, or clear from the context, the phrase “X employs A or B” is intended to mean any of the natural inclusive permutations. That is, the phrase “X employs A or B” is satisfied by any of the following instances: X employs A; X employs B; or X employs both A and B. In addition, the articles “a” and “an” as used in this application and the appended claims should generally be construed to mean “one or more” unless specified otherwise or clear from the context to be directed to a singular form.

What is claimed is:

1. A machine implemented method, comprising:
transmitting identical script extracts to actors in a predefined demographic category;
receiving a number of submissions of video files from the actors comprising recorded performances of the identical script extracts; and
based on the number of submissions and a predefined number of best performances in the demographic category:
determining a number of rounds of evaluation and down-selection; and
determining a number of groups in each round and a number of submissions in each group.

2. The method of claim 1, wherein each round of evaluation comprises one of side-by-side evaluation, round-robin evaluation and bracketed single-elimination evaluation.

3. The method of claim 1, further comprising:
providing the best performances in the demographic category for viewing by registered professionals; and
providing a communication link between an actor and a registered professional in response to a request from the registered professional.

4. A server, comprising:
a processor; and
a memory comprising processor executable instructions that, when executed by the processor, configures the processor to:
transmit identical script extracts to actors in a predefined demographic category;
receive a number of submissions of video files from the actors comprising recorded performances of the identical script extracts; and
based on the number of submissions and a predefined number of best performances in the demographic category:
determine a number of rounds of evaluation and down-selection; and
determine a number of groups in each round and a number of submissions in each group.

5. The server of claim 4, wherein each round of evaluation is configured as one of a side-by-side evaluation, a round-robin evaluation and a bracketed single-elimination evaluation.

6. The server of claim 3, wherein the processor is further configured to:
provide the best performances in the demographic category for viewing by registered professionals; and
provide a communication link between an actor and a registered professional in response to a request from the registered professional.

7. An article of manufacture, comprising a non-volatile machine-readable medium having instructions therein that, when executed by a machine, configure the machine as a server to:
transmit identical script extracts to actors in a predefined demographic category;
receive a number of submissions of video files from the actors comprising recorded performances of the identical script extracts; and
based on the number of submissions and a predefined number of best performances in the demographic category:
determine a number of rounds of evaluation and down-selection; and
determine a number of groups in each round and a number of submissions in each group.

8. The article of manufacture of claim 7, wherein the machine is configured to structure each round of evaluation as one of a side-by-side evaluation, a round-robin evaluation and a bracketed single-elimination evaluation.

9. The article of manufacture of claim 7, further having instructions that configure the machine to:
provide the best performances in the demographic category for viewing by registered professionals; and
provide a communication link between a subscriber and a registered professional in response to a request from the registered professional.

10. A system, comprising:
means for transmitting identical script extracts to actors in a predefined demographic category;
means for receiving a number of submissions of video files from the actors comprising recorded performances of the identical script extracts; and
based on the number of submissions and a predefined number of best performances in the demographic category:
means for determining a number of rounds of evaluation and down-selection; and
means for determining a number of groups in each round and a number of submissions in each group.

11. The system of claim 10, wherein each round of evaluation is configured as one of a side-by-side evaluation, a round-robin evaluation and a bracketed single-elimination evaluation.

12. The system of claim 10, further comprising:
means for providing the best performances in the demographic category for viewing by registered professionals; and
means for providing a communication link between a subscriber and a registered professional in response to a request from the registered professional.
